(19) United States
(12) Patent Application Publication
(10) Pub. No.: US 2026/0245473 A1
(43) Pub. Date: Aug. 20, 2026

(54) METHOD AND SYSTEM FOR PROVIDING A COMPUTER-IMPLEMENTED TEACHING ENVIRONMENT

(71) Applicant: CODIO LTD, London (GB)

(72) Inventors: Elise DIETRICK, Cambridge, MA (US); Mohit CHANDARANA, Cambridge, MA (US); Dmitrii SUCHKOV, London (GB)

(73) Assignee: CODIO Ltd, London, EN (GB)

(21) Appl. No.: 19/159,443

(22) PCT Filed: Feb. 26, 2024
(86) PCT No.: PCT/GB2024/050513

§ 371 Date: Aug. 25, 2025

Related U.S. Application Data
(60) Provisional application No. 63/576,685, filed on Feb. 24, 2023.

(51) Int. Cl. G09B 7/02

(52) U.S. Cl. CPC G09B 7/02

(57) ABSTRACT

A method and system for providing a computer implemented teaching environment are disclosed. A user interface displays teaching content and receives inputs from user activity. A data stream is generated encoding the inputs and is recording the data stream in a data repository. A plurality of intermediate dimensions are generated, each intermediate dimension comprising a measurement on user activity generated, derived or extracted from one or more sources, the sources including the teaching content and the data stream. The generated intermediate dimensions are mapped according to a plurality of mappings, each mapping combining the generated intermediate dimensions to form a summary metric for the mapping. Upon identifying one or more of the summary metrics exceeding a predetermined threshold the user interface is changed corresponding to the respective summary metric or metrics exceeding the predetermined threshold.

### FIELD OF THE INVENTION

The present invention relates to a method and system for providing a computer-implemented teaching environment and in particular to a system and method that is particularly applicable to computer-implemented teaching of computer program coding.

### BACKGROUND TO THE INVENTION

Computer implemented teaching environments have been subject of increased interest and use, particularly since the COVID epidemic forced everyone to adopt distance learning, at least in part. Many teachers now set homework and revision via computer implemented teaching systems. Typically, teaching content is presented, the content often being multimedia and the student then has to use a user interface to enter answers to questions, submit an essay etc. Systems typically mark entries automatically according to a template answer, record the scores achieved and provide a teacher interface that is used both for setting work and reviewing scores and participation.

Particularly since generative artificial intelligence, Al, has become accessible to mainstream users, there have been fears within education that it will be used for plagiarism. Due to the nature of distance learning, this is a particular issue. Some proposed solutions to this apply Al techniques to attempt to detect plagiarism.

In computing education, in particular teaching of computer program coding, there have been many approaches to detecting plagiarism: code similarity checkers such as MOSS and more recent fingerprint comparison algorithms, detecting “suspicious” behaviors or behaviors commonly correlated with dishonesty, such as used in HackerRank (i.e. copy-paste frequency, tab change activity), and qualitative descriptions of student coding history (e.g. ZyBooks Coding Trails, Code Playback tools).

Code similarity checkers such as the Measure of Software Similarity (MOSS) program developed at the University of California at Berkeley by Alex Aiken attempt to find chunks of code that are similar between code files. A number of advancements in these systems have been made to handle common obscurification efforts such as changing variable names and spacing to create superficial differences without affecting underlying structures and program behavior. Some code similarity systems actually combine multiple approaches (i.e. tokenization, abstract syntax tree comparison, etc) into a sortable ranking from most to least suspicious—however, this leaves the onus on the instructor to try to decipher what a meaningful threshold is for suspicious behavior. Historically, these systems have struggled with smaller programs typical of introductory courses which have a limited solution space, particularly in scaled contexts. In other words, when you are comparing a thousand examples of a five-line program, there will be a lot of detected similarities that do not necessarily indicate plagiarism. Additionally, recent technological advances in automated code generation systems such as OpenAI Codex and GPT-J potentially render these approaches moot as illustrated by Biderman and Raff in their 2022 publication “Fooling MOSS Detection with Pretrained Language Models”.

Suspicious behavior detectors, which look for activity such as pasting and navigating to other browser tabs, are one way to address plagiarism detection without having to compare source code like code similarity checkers. While this gets around large language model threats and small solution space concerns, implementations of programming behavior in commercialized products are rather limited and are often implemented as independent of one another. For example, HackerRank counts the number of times a programmer attempts to paste in the code editor, as well as the number of window exits, and the number of seconds outside of the HackerRank window.

Qualitative histories of program creation are another way to address plagiarism. These histories are provided in an effort to illustrate a student's lack of work. For example, ZyBooks Coding Trail illustrates the timeline of submissions, and a lack of submissions may be considered suspicious to an instructor. Other tools, often called Code Playback, show a history of the code (e.g. a literal screen recording, a series of code commits, a sequence of submissions, or a timeline of keystroke-level changes).

Code Playback can be used to manually look for pastes or odd typing patterns that look more like transcription than organic code development. However, while these histories offer a lot of insight into the coding process, they need manual (human) consideration and do not provide a way to prioritize the most suspicious submissions—again leaving the onus on the instructor to manually review these rich visualizations.

The above approaches have a shared problem: as plagiarism detection systems, they are hesitant to declare a submission as plagiarized and so often leave the reviewer with a non-trivial task of understanding complex metrics, combining disparate pieces of information which independently are not convincing, and/or manually reviewing the history of submissions.

There is a distinct line of work in computing education research around detecting struggling students, generally grounded in the stance of helping instructors identify students who are “at risk” of failing either the course or the assignment. Previous work has leveraged a number of data streams from instrumented Integrated Development Environments (IDEs) or code editors such as the number of work sessions, total time spent on the assignment, and percent of submissions that compiled without error. This approach of quantified behavior from IDE logs is not threatened by small solution spaces or large language models like code similarity checkers. Unlike plagiarism, because most of the interventions that are implemented for “at risk” students are generally beneficial, instructors view it as unproblematic to have false positives-that is for not struggling students to benefit from the intervention. This means hard thresholds have been established based on historic data allowing clear labeling of which students are “at risk”-eliminating the burden of manual review. However, these efforts have yet to be commercialized because of their sensitivity to context. Specifically, while predictive power is found in small studies where many IDE features are tested to isolate the few meaningful ones, there is no agreement across studies about which aspects of IDE usage could be reliable in a cross-context tool.

### STATEMENT OF INVENTION

According to an aspect of the present invention, there is provided . . .

The inventors have identified that the above two distinct lines of work described—plagiarism detection and identifying struggling students—are opposite ends of the same spectrum of effort. The lines of work actually reinforce each other. For example, a struggling student is likely to be in other browser tabs consulting the Internet in an attempt to become unstuck. Additionally, a plagiarizing student is likely to show extremely low values on the same metrics used to identify struggles such as the number of characters deleted.

Embodiments of the present invention take a novel approach of combining these two lines of work, which are building systems at either end of the effort spectrum, into a generalized programming effort quantifier. Due to the challenges of low reliability of the current methods to identify struggling programmers and the overwhelming amount of data needed to be reviewed in plagiarism systems to get a definite decision, the present invention combines multiple, intermediate dimensions into a single, triangulated, sortable metric representing programming effort for ease of review.

Finally, the inventors are aware that these intermediate dimensions the present invention is combining have more use cases beyond quantifying programming effort. Carter, Hundhausen, and Olivares compiled a table in the “Leveraging the IDE for Learning Analytics” chapter of the 2019 Cambridge Handbook of Computing Education Research which includes over 20 metrics around programmer time management, the programming process, and program content that can be derived from the same IDE data our invention processes for student effort metrics. This means that the present invention, with minimal configuration changes, can quantify not only developer effort but a wide range of other behaviors of interest including procrastination, flow, and stuckness and in any education fields, not simply coding.

Embodiments of the present invention seek to provide a computer implemented teaching method and system. Although embodiments may be directed to any form of computer implemented teaching system, preferred embodiments concern teaching of computer program coding which interact with a user via an integrated development environment, IDE, which typically provide facilities for software development including a computer program code editor and execution facilities. Preferred embodiments seek to provide a computer implemented method and system for analyzing coding behavior.

Logs of user activity; source code and corresponding resources are processed and two or more intermediate dimensions based on any combination of logs of user activity, the source code and corresponding resources, and other intermediate dimensions are generated. Configuration(s) specifying how the intermediate dimensions are combined are then applied to produce sortable metric(s) summarizing the multiple intermediate dimensions based on the configuration(s). Preferably, the metrics trigger changes, such as a change in behavior of the user interface (blocking pastes if plagiarism is detected, providing extra examples or part of a solution if the user appears to be struggling and guessing, for example). Embodiments of the present invention preferably comprise two or more intermediate dimensions representing coding behaviors derived from user-generated data. These intermediate dimensions are combined into a sortable representation of coding behavior which could be on a categorical scale (e.g. Low, Medium, High) or a numerical scale (e.g. 0-100). The present invention is generalized such that it can be easily re-configured to change which coding behavior is being quantified.

### BRIEF DESCRIPTION OF DRAWINGS

Embodiments of the present invention will now be described, by way of example only, with reference to the accompanying drawings, in which:

FIG. 1 is a schematic diagram of a computer implemented teaching system according to an embodiment;

FIG. 2 illustrates a process flow in accordance with embodiments of the present invention;

FIG. 3 depicts an embodiment of the present invention consisting of a single IDE data stream informing the minimum two intermediate dimensions being combined into a single sortable metric; and,

FIG. 4 depicts a preferred embodiment of the present invention consisting of multiple IDE data streams used in combination to inform several intermediate dimensions being combined into two sortable metrics.

### DETAILED DESCRIPTION

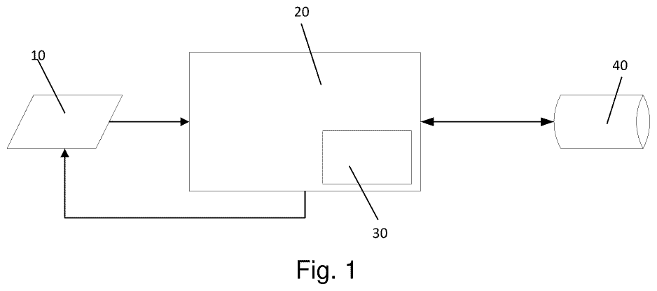

FIG. 1 is a schematic diagram of a computer implemented teaching system according to an embodiment.

A user interface 10 is configured to display teaching content and receive inputs from user activity. The user interface may be executable by a web browser of a user's computing device, it may be a bespoke application that is installed and executed or it may take the form of a plug-in that inter-operates with an existing application on the user's computing device.

The computer implemented teaching system includes a teaching system management module 20 that is executed by a processor 30. The processor 30 may be a processor of the user's computing device or it may be remote, for example hosted on a remote server that interacts with the user interface 10 over a network such as the internet. The teaching system management module includes:
computer program code for receiving the inputs from the user interface 10, generating a data stream encoding the inputs and recording the data stream in a data repository 40;
computer program code for generating a plurality of intermediate dimensions, each intermediate dimension comprising a measurement on user activity generated, derived or extracted from one or more sources, the sources including the teaching content and the data stream;
computer program code for combining the generated intermediate dimensions according to a plurality of mappings, each mapping combining the generated intermediate dimensions to form a summary metric for the mapping; and,
computer program code for identifying one or more of the summary metrics exceeding a predetermined threshold and changing the user interface 10, the change corresponding to the respective summary metric or metrics exceeding the predetermined threshold.

It will be appreciated that when a summary metric exceeds a predetermined threshold, one or more of many changes could be made to the user interface 10, depending on the subject and type of teaching, the age or demographic of users, the type and/or capabilities of the user computing device and other factors. For example, if a teacher sets the configuration to quantify plagiarism, the change to the user interface could be, upon a metric or metrics exceeding the predetermined threshold, to disable the pasting operation into the answer entry window or force a full-screen mode to prevent reference to other information sources. This action may be recorded and/or communicated to the teacher and/or student, sending a warning email to the student that cheating behavior was detected on the assignment. Changes to the user interface may be progressive, adding restrictions and/or providing assistance in an incremental way over time until the metric or metrics indicate normal activity. In the case of restrictions, these may be permanent or applied for a predetermined time period.

The system can make changes to the user interface, either to features of the interface itself or to the teaching content delivered. For example, if the metrics are linked to a student who is struggling, the changes may be accommodations for upcoming assessments (e.g. removing wrong answers, also known as distractors, or changing the assessment type to lower extrinsic cognitive load), generally by allowing the students to use recognition instead of recall. For example, in the case or computer program coding, a struggling student may be set tasks such as Parsons questions [rearranging code blocks] instead of writing code or Multiple Choice instead of Fill in the Blank). The system may also or alternatively provide scaffolding such as a human-readable error message, error highlighting or AI-generated hints.

Embodiments may not necessarily be about poor behavior or performance, they may also be used to encourage those average students who might otherwise be overlooked. For example, if a teacher sets the configuration to quantify creativity, the system can open a separate window panel to present Al-generated suggestions that considers the students answers and provides suggestions improvements/extensions or additional reading sources for all but a predetermined percentile of the highest scoring students and/or provide content and guidance linked to the students' metrics so as to provide pedagogical support linked to their abilities.

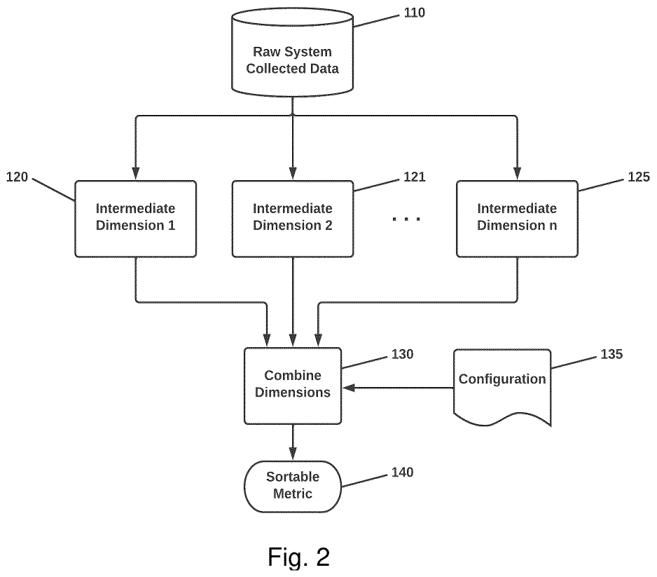

FIGS. 2-4 discuss a preferred embodiment in which the teaching content is teaching computer program coding and the user interface is an integrated development environment, IDE.

The general process flow for embodiments of the present invention is represented in FIG. 2. The process starts with the raw data collected from an IDE or other similar system 110 which is then used to create intermediate dimensions. It will be appreciated that in some embodiments instead of or in addition to the IDE providing user inputs, a supervisor process running in the background could be capturing events on the user device and/or user interface 10, for example.

In preferred embodiments, at least two intermediate dimensions are generated (e.g. 120 and 121), but any number of intermediate dimensions can be specified 125.

The specifics of how to create a particular intermediate dimension will depend on the nature and content of the dimension and examples are discussed below. It will be appreciated that many other examples will be apparent and could be implemented by the skilled person.

The multiple intermediate dimensions are then combined in a process 130 based on a configuration 135. The configuration 135 allows for easy modifications to change or finetune the coding behavior being quantified.

The exact implementation of how the dimensions are combined 130 can also be varied depending on implementation choices. For example, it could be an arithmetic operation, it may be via a weighted sum of values (or normalized values) with weightings emphasizing intermediate dimensions particularly applicable to behaviors, it may be via a machine learning system such as a neural network that has been trained on labelled training data or via some other supervisor system so as to be able to categorize intermediate dimension values and their combinations to specific issues/behaviors.

An embodiment with three intermediate dimensions could easily create a categorical scale such that the resulting sortable metric 140 would be None, Low, Medium, or High by simply counting or summing the number of intermediate dimensions (0-3) which are outside of the thresholds specified in the configuration 135. Another embodiment with more intermediate dimensions or intermediate dimensions of different levels of importance/relevance might use a weighted approach to combine dimensions 130 to create a numerical sortable metric 140 based on weights specified in the configuration 135 similar to: sortable metric=weight₁*dimension₁+weight₂*dimension₂+ . . . +weightₙ*dimensionₙ

The exact formatting of the configuration 135 should be decided based on the specifics of the embodiment. An embodiment whose configuration 135 only needs to contain thresholds that are manually edited might use an easily parsed file format such as YAML or JSON. Another embodiment with a more complex configuration with values that are only accessed by the system might use a database. The type of configuration used for a given embodiment will be determined by the preference and practices of the development team.

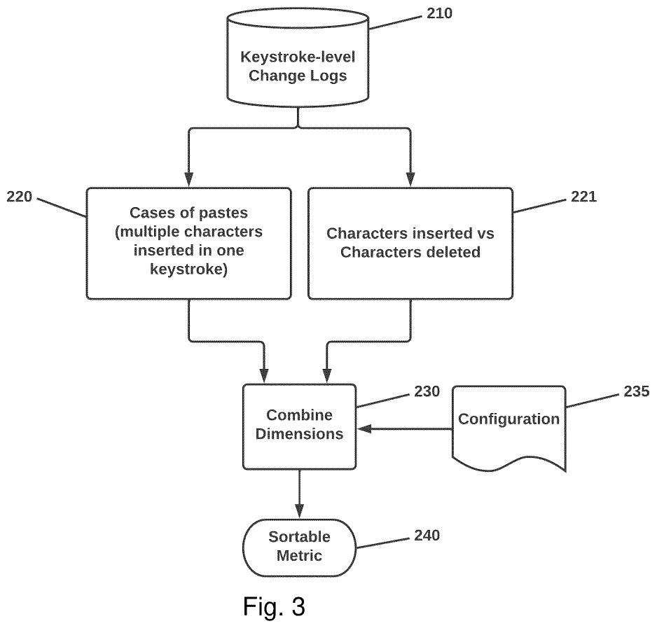

FIG. 3 depicts the flow process for a simple embodiment. There is a single data stream from the IDE—the keystroke-level change logs 210. Keystroke-level change logs include information like the timestamp for the change, the file name, file position, the type of change (insertion or deletion), and the content of the change.

The first intermediate dimension 220 is looking for cases of pastes into the IDE. A paste would be detected by scanning through the keystroke level change log for insertions with multiple characters. This dimension could be quantified by the total number of paste actions and the total number of characters pasted.

The second intermediate dimension 221 is the number of characters inserted and the number of characters deleted. This dimension can be created by summing the number of characters for every insertion and summing the number of characters for every deletion. This dimension could be quantified by the raw character counts and the percent of total character changes.

Based on the example intermediate dimensions (220 and 221) one could configure this system to detect plagiarism. Given the low number of dimensions, one might choose a categorical sortable metric 240 that simply represents the number of dimensions that are beyond a given threshold (as described in paragraph 16). An example configuration 235 for this embodiment might simply contain a threshold for the minimum percent of deletions and the maximum number of characters pasted.

The process (mapping) for combining dimensions 230 would then be checking the total number of pasted characters passed from 220 against the maximum number of characters pasted threshold in the configuration 235 and adding 1 to a counter if the value from 220 is greater than the threshold in 235. The next step would be to compare the percent of characters deleted from 221 to the minimum percent of deletions threshold in the configuration 235 and adding 1 to the counter if the value from 221 is less than the threshold in 235. This counter value is now either 0, 1, or 2. This could be mapped to words (i.e. Low, Medium, High) or simply passed in the numeric form to become the sortable summary metric 240.

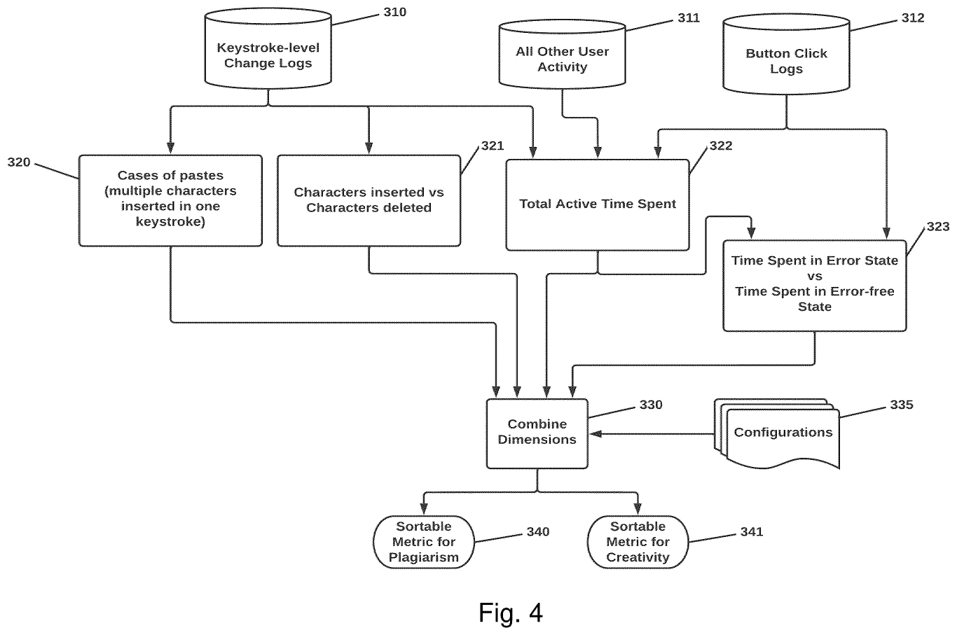

FIG. 4 illustrates a preferred embodiment that expands the simple embodiment depicted in FIG. 3. The keystroke-level change logs 310, cases of pastes 320, and characters inserted/deleted 321 are the same as components depicted in FIG. 3 as 210, 220, and 221, and described in paragraphs 18-20 respectively.

In addition to the keystroke-level change logs 310, the preferred embodiment represented in FIG. 4 uses Button Click Logs 312. Buttons are frequently used in IDEs to trigger specific actions such as compiling or executing the code, launching the debugger, or running a predefined terminal based command (e.g. starting/stopping a web server). Button click logs include information like the timestamp for when the click occurred, the location of the button, the command triggered by the button, the user-facing output from the triggered command, and the exit code of the triggered command.

Embodiments can include intermediate dimensions which consider multiple data streams. For example, all other user activity 311 (e.g. logs of opening and closing IDE panes) is combined with the already specified logs (310 and 312) to determine how much total time was spent when the user was actively engaged with the system 322. Total active time spent 322 could be quantified as a number of seconds.

Additionally, embodiments can include intermediate dimensions that are informed by not only data streams, but also other intermediate dimensions. For example, time spent in error state vs time spent in error-free state 323 combines the intermediate dimensions of total active time spent 322 with the exit code from the button click logs data stream 312. Specifically, time following a button click with a non-zero exit code is labeled as time in an error state while all other time is labeled as time in an error-free state. Time spent in error state vs time spent in error-free state 323 could then be quantified as either the seconds or the percent of time spent in each state.

Keeping with the assumption from FIG. 3 that this embodiment is configured to detect plagiarism and the larger number of intermediate dimensions, one could configure this embodiment to have a numerical sortable summary metric for plagiarism 340 (similar to the description in paragraph 16). This would indicate that the configuration 335 would include not only thresholds for each intermediate dimension but also weights.

The process for combining dimensions 330 would then involve checking each intermediate dimension 320, 321, 322, and 323 against the threshold specified in the configuration 335. If a threshold is passed, the specified weight for that dimension would be added to the counter. The range of the sortable metric for plagiarism 340 would then be 0 to the sum of the weights specified in the configuration 335. To simplify the user's interpretation of the sortable metric, a final step in the process of combining dimensions 330 could be dividing the counter by the sum of the weights so that the resulting sortable metric for plagiarism 340 was a percentage (a number out of 100).

It will be appreciated that changing the configuration 335 can change the output from a sortable summary metric representing plagiarism 340 to, for example, a sortable metric summary representing creativity 341.

In some embodiments, outputting multiple sortable behavioral summary metrics might be desirable. For example, in addition to a metric for plagiarism 340, the reviewer might also want a sortable metric for creativity 341 so both could be considered simultaneously. One approach to this is to simply re-run the entire process with a different configuration, however, that is not optimal in most cases. Instead, a more efficient embodiment might consider two different configurations 335 while combining the intermediate dimensions 330. The preferred embodiment represented in FIG. 4 outputs two sortable behavior metrics 340 and 341, which each summarize the intermediate dimensions, but any number of sortable summary metrics might be generated/outputted.

It will be appreciated that not all intermediate dimensions need have meaningful weight/applicability for all sortable summary metrics. For example, while the cases of pastes 320 might hold significant weight in the configuration 335 for the plagiarism metric 340, the configuration 335 for the creativity metric 341 might weight cases of pastes 320 at or close to zero (in the case of a machine learning system it will be appreciated that the training would implement these weights). Conversely, while the time spent in error or error-free states 323 might hold significant weight in the configuration 335 for the creativity metric 341, the configuration 335 for the plagiarism metric 340 might weight time spent in error or error-free states 323 at or close to zero.

Embodiments discussed above use analysis of keystrokes to identify intermediate dimensions and, in turn, assess whether summary metrics that are linked to behavior or performance are exceeded. It will be appreciated that keystrokes are a rich source of information from which a great deal about a user's activity and ability can be ascertained. However, in order to be useful the keystrokes need to be retained so that they can be collectively analyzed. It may also be the case that certain issues or behaviors cannot be detected form just the keystrokes and their entry pattern and timing may also be considered.

To collect keystroke level changes, preferred embodiments receive inputs from the user interface and record these as a data stream. Preferably, the inputs are recorded in the data stream in the form of change events (some of this data may be added or extrapolated from the inputs at the time it is transformed into the data stream and recorded) comprising:
1. a date/time
2. the user making the change
3. the operation (i.e. insertion or deletion)
4. the change (i.e. the text being inserted or the number of characters being deleted)
5. the location of the change (i.e. line number and column number)

Preferably, for every change event recorded (a direct operation representing the operation as directly captured from the user interface/user's computing device), data is generated and recorded in the data stream corresponding to the change event for a revert operation—the operation to reverse the direct operation.

The direct and revert operations are stored in the data stream as a history collection. Having both allows traversing the collection forward or backward to go forward or backward in the file history easily.

Because user inputs recorded may be extensive, it is processor and resource intensive to have to traverse the entire inputs to reach a particular point. To address this, the data stream is preferably divided into blocks of a predetermined size, for example 200 operations. This may be done during generation of the data stream or afterwards. With this infrastructure, for any given moment in time, we can quickly pull the closest file state from the file collection and then apply at most 100 operations either forward or backward in time to reach the file state at the requested time.

Intermediate dimensions may also be calculated per block and/or taken into account when defining a block—for example a rate of change of an intermediate dimension may trigger a change in block so that each block reflects a particular behaviour and therefore isolates abnormal/unusual behaviour that can be considered/highlighted and played back on demand. A teacher interface preferably is provided that allows visual playback of user behaviour that has been highlighted. By inclusion of play/rewind capability in the data stream of the keypress log (and this can be replicated in other logs such as the button press log), the teacher can view at different rates, rewind etc as needed to identify issues and/or check and dismiss false positives determined by the system.

It is to be appreciated that certain embodiments of the invention as discussed above may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

This application claims priority from U.S. 63/576,685, the content of which, along with the content of the abstract filed herewith, is incorporated by reference herein.

1. A computer implemented teaching system comprising:
a user interface configured to display teaching content and receive inputs from user activity;
a data repository;
a processor configured to execute computer program code for executing a teaching system management module including:
computer program code for receiving the inputs from the user interface, generating a data stream encoding the inputs and recording the data stream in the data repository;
computer program code for generating a plurality of intermediate dimensions, each intermediate dimension comprising a measurement on user activity generated, derived or extracted from one or more sources, the sources including the teaching content and the data stream;
computer program code for combining the generated intermediate dimensions according to a plurality of mappings, each mapping combining the generated intermediate dimensions to form a summary metric for the mapping; and,
computer program code for identifying one or more of the summary metrics exceeding a predetermined threshold and changing the user interface, the change corresponding to the respective summary metric or metrics exceeding the predetermined threshold.

2. The computer implemented teaching system of claim 1, wherein one or more of the mappings is selected from a set comprising:
a weighted sum of the intermediate dimensions;
one of more of the mappings comprises a machine learning system; and
a count of the number of intermediate dimensions exceeding a respective predetermined threshold.

3. (canceled)

4. (canceled)

5. The computer implemented teaching system of claim 1, wherein the mappings are editable.

6. The computer implemented teaching system of claim 1, wherein the user interface is an Integrated Development Environment, IDE, and the teaching content includes computer program coding examples, the user activity including editing computer program code in the IDE corresponding to the computer coding examples.

7. The computer implemented teaching system of claim 6, wherein the teaching content includes a computer program coding example provided to the user in a code editor of the IDE, the user activity including editing the computer program coding example in the code editor of the IDE.

8. The computer implemented teaching system of claim 6, wherein the inputs from the user interface include a keystroke-level change log, the computer program code for receiving the inputs from the user interface, generating a data stream encoding the inputs and recording the data stream in the data repository includes computer program code for generating the data stream from the keystroke-level change log, the data stream including a timestamp for the change, a type of change, the type including insertion or deletion, and a content of the change.

9. The computer implemented teaching system of claim 8, wherein a first intermediate dimension comprises pastes into the IDE, the computer program code for generating the intermediate dimensions including computer program code for scanning the data stream for insertions with multiple characters and incrementing a count for the first intermediate dimension for each insertion with multiple characters.

10. The computer implemented teaching system of claim 8, wherein a second intermediate dimension comprises a number of characters inserted, the computer program code for generating the intermediate dimensions including computer program code for scanning the data stream for insertions with multiple characters and incrementing a count for the second intermediate dimension by the number of characters inserted.

11. The computer implemented teaching system of claim 10, wherein a third intermediate dimension comprises a number of characters deleted, the computer program code for generating the intermediate dimensions including computer program code for scanning the data stream for deletions and incrementing a count for the third intermediate dimension by the number of characters deleted.

12. The computer implemented teaching system of claim 11, wherein a fourth intermediate dimension comprises a percent of total character changes, the computer program code for generating the intermediate dimensions including computer program code for calculating a percent of total character changed from the second and third intermediate dimensions and optionally from a count of number of characters provided by the teaching content.

13. The computer implemented teaching system of claim 8, wherein the inputs from the user interface include a button click log including a timestamp for when a button click in the user interface occurred and data on the button clicked.

14. The computer implemented teaching system of claim 13, wherein the sources include other intermediate dimensions.

15. The computer implemented teaching system of claim 14, wherein a further intermediate dimension comprises active time measure, the inputs from the user interface including logs of opening and closing IDE panes, the computer program code for generating the intermediate dimensions includes computer program code for combining the inputs from the user interface to determine how much total time was spent when the user was actively engaged with the system.

16. The computer implemented teaching system of claim 15, wherein a further intermediate dimension comprises a measure comparing time spent in an error state to time spent in error-free state, the computer program code for generating the intermediate dimensions includes computer program code for combining the intermediate dimension for active time measure with a timestamp from the button click log when the IDE determined the code was error-free.

17. The computer implemented teaching system of claim 8, wherein the computer program code for receiving the inputs from the user interface, generating a data stream encoding the inputs and recording the data stream in the data repository includes computer program code for generating a revert operation for each change recorded in the datastream from the keystroke-level change log and recording the revert operation in the datastream linked to the change operation, whereby the datastream encodes, and is usable to selectively replay, the changes in a forward and a reverse direction.

18. The computer implemented teaching system of claim 17, wherein the computer program code for encoding the inputs includes computer program code for dividing the datastream into blocks of changes.

19. The computer implemented teaching system of claim 18, wherein the blocks are of a predetermined size.

20. The computer implemented teaching system of claim 18, wherein the computer program code for encoding the inputs includes computer program code for changing the size of a block in dependence on a detected rate change associated with the inputs.

21. The computer implemented teaching system of claim 18, wherein the blocks are time-indexed in the datastream.

22. The computer implemented teaching system of claim 1, wherein the computer program code for identifying one or more of the summary metrics exceeding a predetermined threshold and changing the user interface includes computer program code for blocking paste actions into the user interface.

23. The computer implemented teaching system of claim 1, wherein the computer program code for identifying one or more of the summary metrics exceeding a predetermined threshold and changing the user interface includes computer program code for generating a prompt from the user interface to aid the user.

24. The computer implemented teaching system of claim 1, wherein the computer program code for identifying one or more of the summary metrics exceeding a predetermined threshold further includes sending a communication to a teacher associated with the user highlighting the summary metric exceeding the predetermined threshold.

25. A computer implemented teaching method comprising:
outputting, via a user interface, teaching content;
receiving, via the user interface, inputs from user activity;
generating a data stream encoding the inputs and recording the data stream in a data repository;
generating a plurality of intermediate dimensions, each intermediate dimension comprising a measurement on user activity generated, derived or extracted from one or more sources, the sources including the teaching content and the data stream;
combining the generated intermediate dimensions according to a plurality of mappings, each mapping combining the generated intermediate dimensions to form a summary metric for the mapping; and,
identifying one or more of the summary metrics exceeding a predetermined threshold and changing the user interface, the change corresponding to the respective summary metric or metrics exceeding the predetermined threshold.

26. A computer implemented teaching system comprising:
a user interface configured to display teaching content and receive inputs from user activity;
a data repository;
a processor configured to execute computer program code for executing a teaching system management module including:
computer program code for receiving the inputs from the user interface, generating a data stream encoding the inputs and recording the data stream in the data repository;
computer program code for generating a plurality of intermediate dimensions, each intermediate dimension comprising data generated, derived or extracted from one or more sources, the sources including the teaching content and the data stream;
computer program code for combining the generated intermediate dimensions according to a mapping, the mapping combining the generated intermediate dimensions to form a summary metric for the mapping; and,
computer program code for identifying the summary metric exceeding a predetermined threshold and triggering, via the computer implemented teaching system, a pedagogical intervention corresponding to the summary metric exceeding the predetermined threshold.
